(19) United States
(12) Patent Application Publication
(10) Pub. No.: US 2001/0039561 A1
(43) Pub. Date: Nov. 8, 2001

(54) Method for notifying message reception by e-mail in voice mail system

(75) Inventor: Yi-Tae Cho, Songnam-shi (KR)

Correspondence Address: Steve S. Cha, Esq., Klauber & Jackson, 411 Hackensack Avenue, Hackensack, NJ, 07601, US

(73) Assignee: SAMSUNG ELECTRONIC CO., LTD.

(21) Appl. No.: 09/728,039

(22) Filed: Dec. 1, 2000

(30) Foreign Application Priority Data
Dec. 3, 1999 (KR) 1999-54731

(51) Int. Cl. G06F 15/16

(52) U.S. Cl. 709/200

(57) ABSTRACT

Disclosed is a method for notifying message reception to a personal computer by Email when the message is received in the voice mail system through an exchange using a voice mail service function. The method includes the steps of: registering an E-mail address in the voice mail system using a phone; storing the voice message received at the voice mail system; determining whether an E-mail notification function is set; transmitting corresponding voice message information to the registered E-mail address of the E-mail server if the E-mail notification function is set; transmitting an attached file of the received voice message to the personal computer of the E-mail subscriber with the registered E-mail address, and displaying the attached file on a message window of the personal computer in order to notify message reception in the voice mail system; and, reproducing, using the personal computer, the received message in sound when the user opens the attached file displayed on the message window.

### CLAIM OF PRIORITY

This application makes reference to and claims all benefits accruing under 35 U.S.C. Section 119 from an application for “Method for Notifying Message Reception by E-Mail in Voice Mail System” filed in the Korean Industrial Property Office on Dec. 3, 1999 and there duly assigned Ser. No. 99-54731.

### BACKGROUND OF THE INVENTION

1. Field of the Invention

The present invention relates generally to a method for notifying message reception by E-mail in a voice mail system. More particularly, the present invention relates to a method for transmitting, upon receiving a message at the voice mail system, the number of received messages, the sender's phone number, the date/time when the message is received, and the content of the received message to a designated E-mail address.

2. Description of the Related Art

An E-mail service feature is used mainly to exchange information between computer users. Also, a mobile phone and a radio paging terminal (i.e., pager) are equipped with a voice mail function, so that a user of the mobile phone or the radio paging terminal can leave voice message and phone number for the other party.

A detailed description of the voice mail service will be made below with reference to the mobile phone, as a way of example. When the mobile phone is turned off or is located in a non-serviceable area, an incoming call is transferred to a voice mail system (VMS). A caller connected to the voice mail system can leave a character message (e.g., phone number) or a voice message in response to an outgoing message provided from the voice mail system. When a short message service (SMS) function is set in the mobile phone to inform the user of the received message, the voice mail system notifies the reception of a message to a mobile phone. If the SMS function is not set in the mobile phone for such a service, the voice mail operation is terminated.

Upon receipt of a message reception alarm notifying the user, the mobile phone user has to make a phone call to the voice mail system and thereafter input a password to retrieve the message left in the voice mail system.

As described above, when the mobile phone is turned off or is located in a non-serviceable area, the caller can leave a message to the intended mobile phone user. Then, the user of the mobile phone can check the number of unread messages as well as the content of the received message through a short message center (SMC). In this case, however, the user of the mobile phone has to make a call connection to the voice mail system and input a password to check and retrieve the received message, thus such a message retrieval operation is very inconvenient to the mobile phone user.

### SUMMARY OF THE INVENTION

It is, therefore, an object of the present invention to provide a method for transmitting, when a voice message is received at the voice mail system, the received voice message to a designated E-mail address and notifying the message reception to a terminal (PC) registered in an E-mail server.

It is another object of the present invention to provide a method for allowing a user to retrieve the voice mail received at the voice mail system thorough the personal computer registered in the E-mail server, by opening the attached file transmitted from the voice mail system.

To achieve the above and other objects, a method for notifying, when a message is received at the voice mail system from an exchange via the voice mail service function, message reception to a personal computer by E-mail is provided. The method comprises the steps of: registering an E-mail address in the voice mail system using a telephone; storing a voice message received at the voice mail system; determining whether an E-mail notification function is set; transmitting corresponding voice mail information to the registered E-mail address in an E-mail server if the E-mail notification function is set; and, transmitting an attached file of the received voice message to a personal computer of an Email subscriber having the registered E-mail address and displaying the attached file on a message window of the personal computer, thereby to notify message reception at the voice mail system.

According to another aspect of the present invention, the personal computer reproduces the received voice message when the user opens the attached file displayed on the message window,

### BRIEF DESCRIPTION OF THE DRAWINGS

The above and other objects, features, and advantages of the present invention will become more apparent from the following detailed description when taken in conjunction with the accompanying drawings in which:

FIG. 1 is a diagram illustrating a system for transmitting a voice message received at the voice mail system to a designated E-mail address according to the embodiment of the present invention;

FIG. 2 is a flow chart illustrating a procedure for registering an E-mail address in the voice mail system according to the embodiment of the present invention; and,

FIG. 3 is a flow chart illustrating a procedure for automatically transmitting message reception information from the voice mail system to a personal computer by Email according to the embodiment of the present invention.

### DETAILED DESCRIPTION OF THE PREFERRED EMBODIMENT

A preferred embodiment of the present invention will be described herein below with reference to the accompanying drawings. For the purpose of clarity, well-known functions or constructions are not described in detail as they would obscure the invention in unnecessary detail.

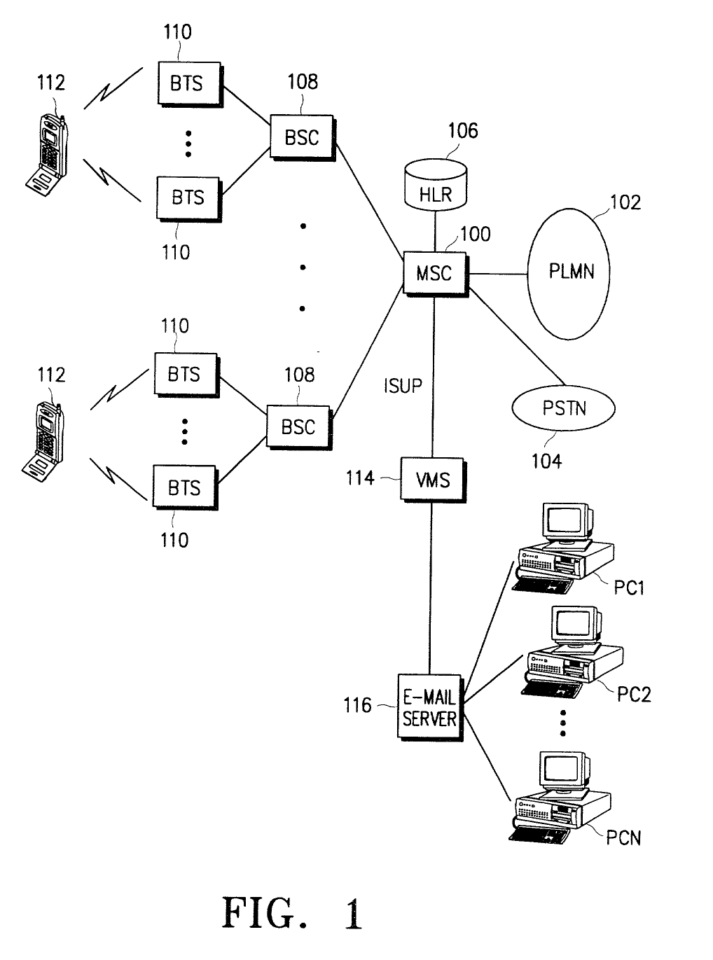

FIG. 1 illustrates a system for transmitting a voice mail received at a voice mail system to a designated E-mail address according to the embodiment of the present invention.

With reference to FIG. 1, a mobile network includes a mobile switching center (MSC) 100, a home location register (HLR) 106, a plurality of base station controllers (BSCs) 108, and a plurality of base transceiver stations (BTSs) 110. The mobile network is connected wirelessly to a plurality of mobile phones 112, a public switched telephone network (PSTN) 104, and a public land mobile network (PLMN) 102. The BSCs 108 control the radio link and the wire link, and perform a handoff function. The BTSs 110 form radio links to the mobile phones 112 and manage radio resources. The HLR 106 performs a subscriber location registration function. A voice mail system (VMS) 114 stores an outgoing message for a message sender and the content of the messages to be transmitted to a voice mail service subscriber. Upon receipt of a message, the VMS 114 notifies the number of the received voice messages to the voice mail service subscriber and the message sender's phone number to the mobile phone 112 through the MSC 100. At the same time, the VMS 114 transmits the voice message stored to the file of an E-mail server 116. The E-mail server 116 stores the voice message received from the VMS 114, the number of the received voice messages, and the message received date/time, then transmits these information to a specific E-mail address via a plurality of personal computers (PCs). The personal computers PC1-PCN receive the number of the received messages, the sender's phone number and the message received date/time from the E-mail server 116, and in turn display the received information on the message window. When the user of a personal computer clicks or opens the attached file of the voice message, the personal computer reproduces the attached file through a sound card and outputs the reproduced voice message through a speaker.

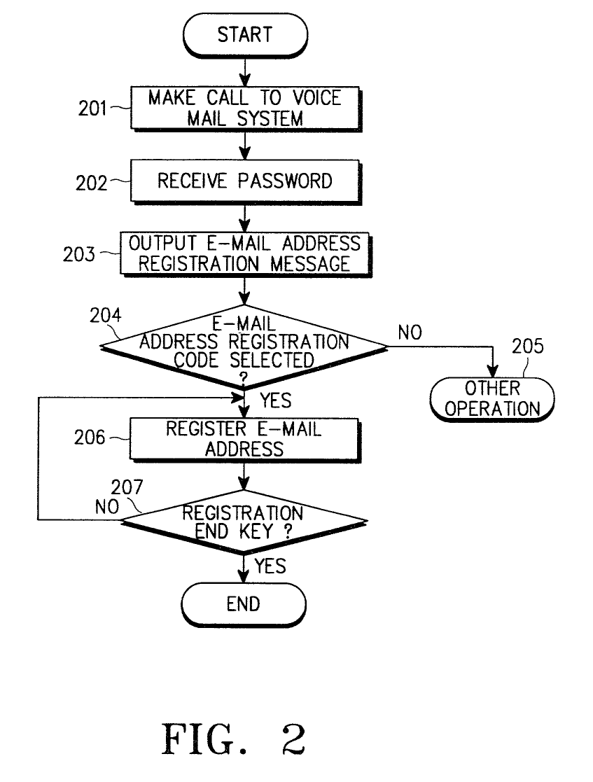

FIG. 2 illustrates a procedure for registering an E-mail address in a voice mail system according to the embodiment of the present invention.

With reference to FIG. 2, a user accesses the voice mail system 114 through his mobile phone 112 or a wire telephone connected to the PSTN 104 in step 201. The voice mail system 114 then outputs an outgoing message requesting the user to input a password in step 202. In response to the password input request message, the user will input his or her password that was assigned previously. Then, in step 203, the voice mail system 114 transmits an outgoing voice message to start the E-mail address registration. For example, the outgoing voice message may be as follows: “Please, press ‘1’ for voice recording, ‘2’ for mobile phone paging, and ‘3’ for E-mail address registration”. The voice mail system 114 determines in step 204 whether an E-mail address registration code (i.e., ‘3’) is selected. If the E-mail address registration code is not selected, other operation corresponding to the key input is performed in step 205.

Otherwise, when the E-mail address registration code is selected, the voice mail system 114 registers the E-mail address inputted by the user in step 206. The user may input the E-mail address through the mobile phone by voice, for example, by pronouncing ‘S’, ‘A’, ‘M’, ‘S’, ‘U’, ‘N’, ‘G’ using the voice recognition function, or using a keypad of the mobile phone. After registering the E-mail address, the voice mail system 114 determines in step 207 whether a registration end key (e.g., *-key) is input (or pressed). If the registration end key is not input, the voice mail system 114 returns to step 206. If the registration end key is activated, the voice mail system 114 ends the E-mail address registration operation.

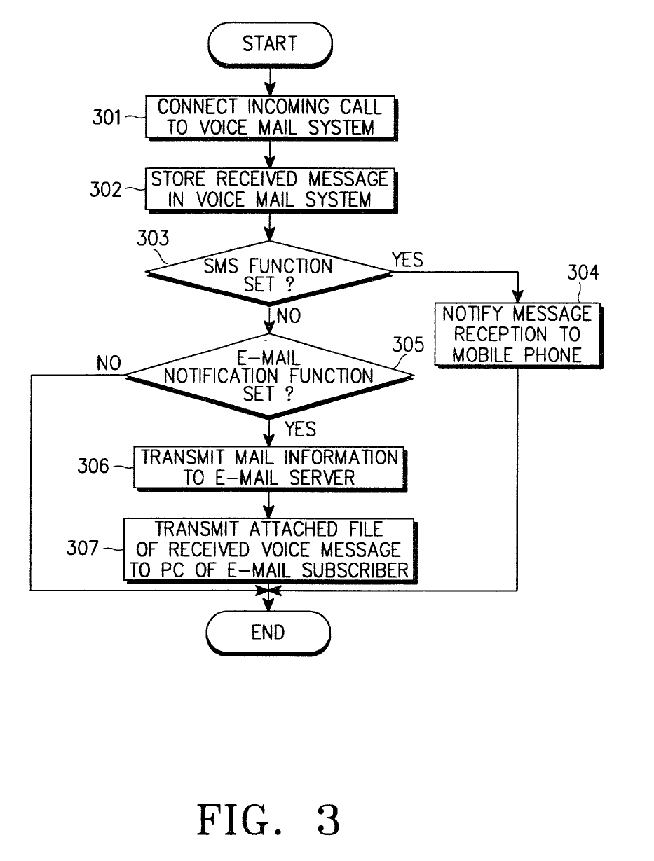

FIG. 3 illustrates a procedure for automatically transmitting the message reception information from the voice mail system, via E-mail service, to a terminal capable of receiving an E-mail (hereinafter referred to as an E-mail reception terminal).

A personal computer, such as a desk-top computer, notebook computer, and a palm-top computer, is used as the E-mail reception terminal. Also, it can be easily understood by those skilled in the art that a terminal capable of receiving an E-mail, such as a mobile phone and a personal digital assistant (PDA) supporting a radio data communication service, can be used as E-mail reception terminal. Herein, the present invention will be described with reference to an example where the E-mail reception terminal is assumed to be a personal computer.

With reference to FIG. 3, in step 301, an incoming call is connected to the voice mail system 114 when the mobile phone is turned off or is located in a non-serviceable area. In step 302, the caller (or sender) leaves a voice message or a character message in response to an outgoing message from the voice mail system 114 requesting to leave a message. Thereafter, it is examined in step 303 whether the SMS function is activated in the mobile phone. When the SMS function is activated in the mobile phone, the voice mail system 114 notifies the reception of a message to the mobile phone. The mobile phone then generates a beep tone to inform the user that a message has been received in the voice mail system 114.

If the SMS function is not set/activated in the mobile phone, it is determined in step 305 whether an E-mail notification function is set/activated. If the E-mail notification function is set, the voice mail system 114 transmits the number of received messages, the date/time when each message was received, and the caller's ID (or phone number) together with the voice mail to the E-mail server 116 according to the TCP/IP protocol, in step 306. Then, in step 307, the E-mail server 116 transmits the voice mail as an attached file to the Email subscriber's personal computer. At this point, a message window will be displayed on the E-mail subscriber's personal computer, and the number of received messages, the date/time when the message was received, the caller's ID and the attached filed are displayed on the message window. When the user clicks or opens the attached file displayed on the message window, the received voice message is reproduced through the sound card of the personal computer and output the voice message through the speaker. Accordingly, the user can retrieve the voice message left at the voice mail system by the sender without making a call connection to the voice mail system using a phone as in the prior art.

Although the present invention has been described with reference to the mobile phone, the same can also be applied even to a wire telephone or a pager. As described above, a user can immediately retrieve the voice message left at the voice mail system by the sender without making a call connection to the voice mail system, and further check the number of received messages, the date/time when message was received, and the content of the received message through voice mail feature using the personal computer. As a result, user can save charge related to a call connection to retrieve the message received at the voice mail service center.

While the invention has been shown and described with reference to a certain preferred embodiment thereof, it will be understood by those skilled in the art that various changes in form and details may be made therein without departing from the spirit and the scope of the invention as defined by the appended claims.

What is claimed is:

1. A method for notifying a voice message reception to a terminal capable of receiving an E-main when a message is received in a voice mail system, the method comprising the steps of:
storing a voice message received at the voice mail system;
transmitting the voice message and information related to the voice message to a mail server according to a previously registered E-mail address; and
transmitting the voice message and the information related to the voice message to the terminal capable of receiving an E-mail according to the E-mail address registered in the mail server;
wherein the information related to the voice message is included in a message part of the E-mail and the voice message is attached to the E-mail in the form of a file, when transmitting the voice message and the information related to the voice message to the mail server.

2. The method as claimed in claim 1, further comprising the step of reproducing the received voice message in the terminal capable of receiving an E-mail by executing the file attached to the E-mail, when the terminal capable of receiving an E-mail receives the voice message and the information related to the voice message.

3. A method for notifying a voice message reception to a terminal capable of receiving an E-main when a message is received in a voice mail system, the method comprising the steps of:
registering an E-mail address in the voice mail system using a telephone;
storing a voice message received at the voice mail system;
determining whether an E-mail notification function is set;
transmitting the voice message and information related to the voice message to an Email server according to a registered E-mail address, when the E-mail notification function is set; and
transmitting the voice message and the information related to the voice message to the terminal capable of receiving an E-mail according to the registered E-mail address;
wherein the information related to the voice message is included in a message part of the E-mail and the voice message is attached to the E-mail in the form of a file, when transmitting the voice message and the information related to the voice message to the mail server.

4. The method as claimed in claim 3, further comprising the step of reproducing the received voice message in the terminal capable of receiving an E-mail by executing the file attached to the E-mail, when the terminal capable of receiving an E-mail receives the voice message and the information related to the voice message.

5. The method as claimed in claim 4, further comprising the steps of:
after storing the received voice message, determining whether an SMS (Short Message Service) function is set; and
notifying the terminal of message reception when the SMS function is set.

6. The method as claimed in claim 1, wherein the information related to the voice message includes date and time when the voice message is received, a phone number of a person who has left the voice message, and the total number of the voice messages stored in the voice mail system.

7. The method as claimed in claim 2, wherein the information related to the voice message includes date and time when the voice message is received, a phone number of a person who has left the voice message, and the total number of the voice messages stored in the voice mail system.

8. The method as claimed in claim 1, wherein the terminal capable of receiving an E-mail is a personal computer.

9. The method as claimed in claim 2, wherein the terminal capable of receiving an E-mail is a personal computer.

10. The method as claimed in claim 3, wherein the terminal capable of receiving an E-mail is a personal computer.

11. The method as claimed in claim 1, wherein the terminal capable of receiving an E-mail is a Personal Digital Assistant (PDA).

12. The method as claimed in claim 2, wherein the terminal capable of receiving an E-mail is a Personal Digital Assistant (PDA).

13. The method as claimed in claim 3, wherein the terminal capable of receiving an E-mail is a Personal Digital Assistant (PDA).

14. The method as claimed in claim 1, wherein the terminal capable of receiving an E-mail is a mobile phone which can support a radio data communication service.

15. The method as claimed in claim 2, wherein the terminal capable of receiving an E-mail is a mobile phone which can support a radio data communication service.

16. The method as claimed in claim 3, wherein the terminal capable of receiving an E-mail is a mobile phone which can support a radio data communication service.

17. The method as claimed in claim 3, wherein the E-mail address is registered in the voice mail system by recognizing a voice of the user.

18. The method as claimed in claim 3, wherein the information related to the voice message includes date and time when the voice message is received, a phone number of a person who has left the voice message, and the total number of the voice messages stored in the voice mail system.

19. The method as claimed in claim 4, wherein the information related to the voice message includes date and time when the voice message is received, a phone number of a person who has left the voice message, and the total number of the voice messages stored in the voice mail system.
